(19) United States
(12) Patent Application Publication
(10) Pub. No.: US 2009/0219735 A1
(43) Pub. Date: Sep. 3, 2009

(54) Structure for light emitting device array

(76) Inventors: Feng Li, Oxnard, CA (US); Gang Xu, Cupertino, CA (US); Bingwen Liang, Sunnyvale, CA (US); Chen-Jean Chou, New City, NY (US)

Correspondence Address: CHEN-JEAN CHOU, 21 RIDGEFIELD ROAD, NEW CITY, NY, 10956, US

(21) Appl. No.: 12/396,442

(22) Filed: Mar. 2, 2009

Related U.S. Application Data
(60) Provisional application No. 61/032,981, filed on Mar. 2, 2008.

(51) Int. Cl. F21V 8/00

(52) U.S. Cl. 362/621

(57) ABSTRACT

Structure for polarized light source suitable for the application of flat panel display is provided.

### CROSS REFERENCE TO RELATED APPLICATIONS

The present application claims priority of U.S. Provisional Patent Application No. 61/032,981, filed on Mar. 2, 2008.

### BACKGROUND OF THE INVENTION

1. Field of the Invention

The present invention relates to the polarization of light source. More specifically, the present invention provides a structure and method to produce polarized light applicable for display devices requiring polarized light source, such as liquid crystal display.

2. Description of the Prior Art

Light source currently used in a flat panel display is first distributed through a light guide to illuminate the entire area of the display. The light then passes through a polarizing film of the same size as the display area. An example of such device is provided in FIG. 1 wherein the light source 101 and the reflector 102 direct the light to a light guide 103. The structures 104, arranged on one face of the light guide 103 and a reflecting surface placed behind this face, direct the light traversing the light guide toward the opposite face of the light guide where the light exits the light guide and illuminates a display screen. The light exiting the light guide is not polarized as shown to comprise polarization components 111 and 112 in FIG. 1. A sheet polarizer of the same size as the image display screen is placed between the light guide and the image display screen to produce linearly polarized light to illuminate the image display screen. Such display structure requires a large area polarizing film, the same size as the display. Furthermore, a polarizing film removes 50% of the light from the incoming non-polarized light. An ordinary polarizer allows light of one polarization 111 to transmit and removes the orthogonal polarization 112 from the light. The removed light is typically absorbed or dispersed and mostly lost as heat. In order to improve the efficiency of light utilization, special material and structure have to be processed into the polarizing film to reflect, rather than absorb, the light of orthogonal polarization. The reflected light is then re-processed and re-directed back into the system. An example of such film is DBEF. A typical structure using such polarizer is shown in the right part of FIG. 1 where 105 is a DBEF that allows the polarization 113 to transmit and reflects the orthogonal polarization light 114. The special material and structure of such film increases the cost. This is particularly unfavorable when such cost is scaled with the size of the display.

Furthermore, as re-processing the reflected light involves multiple passes of the light back and forth between the reflector 106 and DBEF, the light passes through dispersing and absorbing elements such as structure 104 multiple times. The efficiency of light utilization is still very limited even with such conventional re-processing structures.

The present invention provides a structure and method to improve on both factors.

### SUMMARY OF THE INVENTION

The present invention provides a method and structure to produce light polarization before the light entering the large area light guide typical used in a flat panel display. In this invention, the polarization is generated in a fairly confined area before distributing to illuminate a large area. Two orthogonal polarizations are created and directed to different paths. In one preferred embodiment, one component of the polarized light is re-directed to an optically active device to have its polarization modified to be the same as the first before merging into the optical path of the first component. High utilization of light and small area processing thus provide improved efficiency in both energy and material.

### BRIEF DESCRIPTION OF THE DRAWINGS

FIG. 1 is a schematic of a prior art light source.

FIG. 2 is a schematic illustration of the present invention.

FIG. 3 is a schematic illustration of the present invention.

FIG. 4 is a drawing of a preferred embodiment of the present invention.

FIG. 5 is a schematic drawing of the present invention.

FIG. 6 is a schematic illustration of light distribution structure in the present invention.

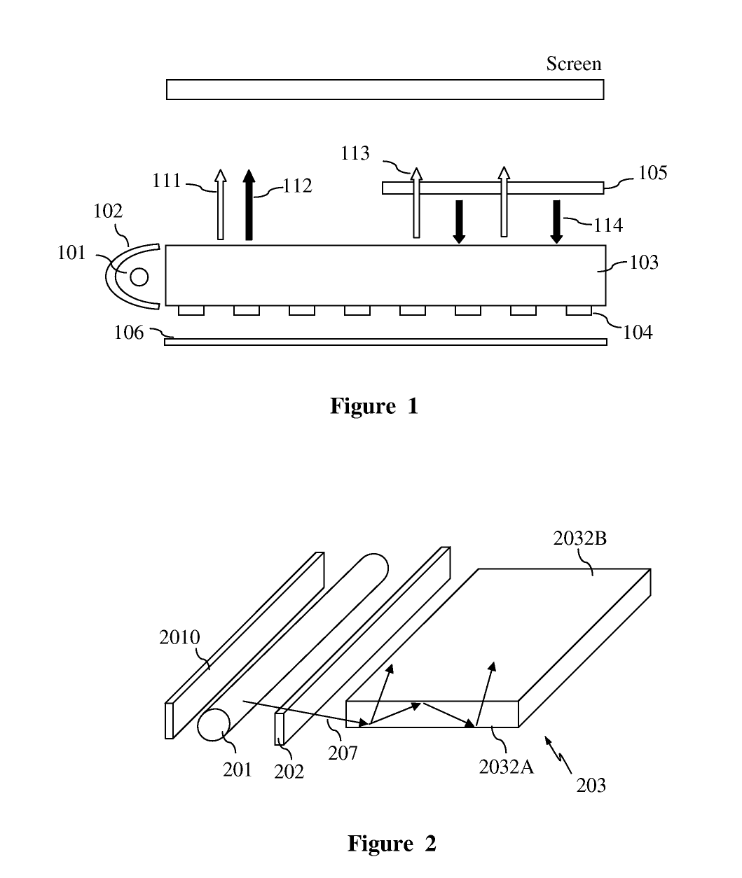

### DETAILED DESCRIPTION OF THE INVENTION

The present invention is herein described in detail with reference to the drawings.

FIG. 2 illustrates the schematic of a preferred embodiment of the present invention, wherein an apparatus comprises a light source 201, a light guide 203, and a polarizer arranged between the light source and the light guide. The light is polarized via a polarizer 202 in a small area before entering the small face of the light guide, thereby reducing the size of the polarizer.

The light guide 203 comprises light re-directing structures on one of its large faces 2032A. Such structures preserve the polarization, and direct the traversing light toward and to exist the opposite large face 2032B of the light guide.

The light source may further comprise structures such as reflector 2010 or collimator to direct light toward the light guide.

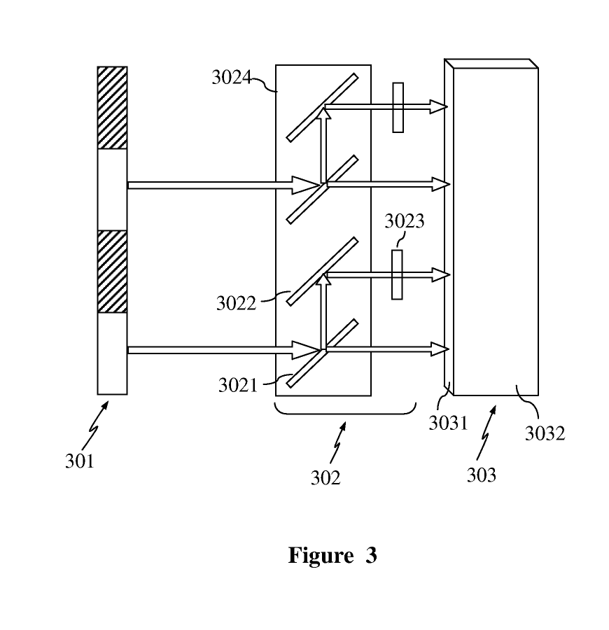

FIG. 3 provides further detail of a preferred embodiment of the present invention, where 301 is a light source, 303 is a light guide, and 302 is an assembly of polarizer comprising multiple elements of polarizer shown as 3021, 3022 and so on. The polarizer is arranged between the light source 301 and the light guide 303. The light from the light source 301 is directed to the polarizer 302 and become polarized before entering the light guide.

In a preferred embodiment, the polarizer assembly 302 may further comprise an optical active element 3023 positioned between the polarizer element 3022 and the optical guide 303.

In a preferred embodiment, said light guide 303 comprises a face 3031 of small area, and a face 3032 of large area. The apparatus is arranged so that the light emerging form the polarizer is directed into the light guide via the face 3031 of small area, and exiting the light guide via the face 3032 of large area.

In a preferred embodiment the polarizer assembly 302 further comprises an enclosure element 3024. Such enclosure element provides mechanical support to the elements of polarizer 3021 and 3022. One preferred embodiment of the enclosure element 3024 is a mechanical frame supporting the polarizer 302 and 3022. The mechanical frame is made to fix the polarizer in positions. Another preferred embodiment of the enclosure 3024 is a bonding chemical that bonds the polarizers into one unit.

In a preferred embodiment, the polarizer elements 3021 and 3022 are integrated as facets within the host 3024, and the integrated polarizer assembly 302 is constructed as a single slab or film. One preferred method of making such assembly is to immerse or embed polarizer 3021 and 3022 in transparent epoxy resin or polymer which is the host material. The host material is cured or solidified and molded into the shape of the assembly slab. Another preferred method of producing such embodiment is to immerse the polarizer 3021 and 3022 in polycarbonate plastic.

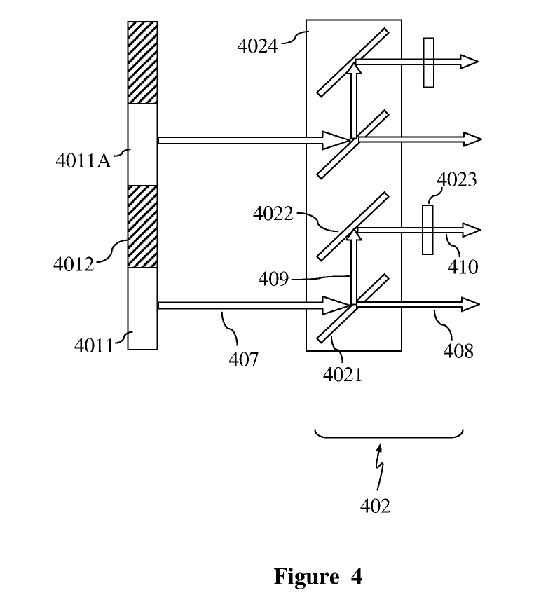

FIG. 4 provides further detail of a preferred embodiment and a preferred operation of the present invention. The light source comprises at least one light element 4011. The polarizer assembly 402 comprises multiple elements of polarizer 4021 and 4022, and an optically active element 4123. The light output 407 from the light element 401 is directed to a polarizing element 4021. Polarizer 4021 splits light beam 407 into two orthogonal polarization light beams 408 and 409, where light 408 is transmitting with one polarization and 409 is reflected by 4021 and polarized orthogonally to the polarization of 408. The polarizer 4021 is arranged to direct the reflected light 409 to a second polarizer 4022, where polarizer 4022 is oriented to reflect the polarized light 409. The reflection by polarizer 4022 re-directs light 409 into a direction of 410 which is in the same direction of light 408. Light 410 passes through an optically active element 4023 before merging into the direction of light 408. The optically active element 4023 operates to re-orient the polarization of 410 to the same polarization orientation as of light 408. The emerge lights of 408 and 410 thus comprise the same polarization.

In a preferred embodiment, the optically active element comprises material that rotates a polarization by an angle. Examples of such optically active materials comprise quartz, calcite, and certain organic materials comprising polyamide, polyester and polyimide. The device is so prepared that rotates the polarization of light 410 by an amount equal to the angular difference between the two orthogonal polarizations so that the light 410 emerging from the device 4023 has its polarization aligned in the same orientation as the transmissive light 408.

In a preferred embodiment, the polarizing element comprises a plurality of alternating layers of different indices of refraction, thereby allowing one polarization to pass and reflecting the orthogonal polarization.

In another preferred embodiment, said polarizing elements comprise a plurality of repeating stacks; wherein each stack comprises at least two layers; wherein one of the two layers is optically anisotropic; wherein said two layers have substantially similar indices of refraction in one direction of polarization, and different indices of refraction in the other direction of polarization.

In another preferred embodiment, said polarizing elements comprise grating with parallel metal wires. In a preferred embodiment such metal wires stretch perpendicular to the light path, where the spacing between the metal wires and the thickness of the metal wires are in the same order of magnitude of the wavelength of the visible light.

In a preferred embodiment, the light source may be further structured with a plurality of light elements shown as 4011 and 4011A in FIG. 4, where each light element directs its light output to an element of polarizer in the polarizer assembly, as illustrated in FIG. 4. The light elements are separated by a structure 4012, such as collimating device or isolation reflectors, to direct the light 407 to the corresponding polarizing element 4021.

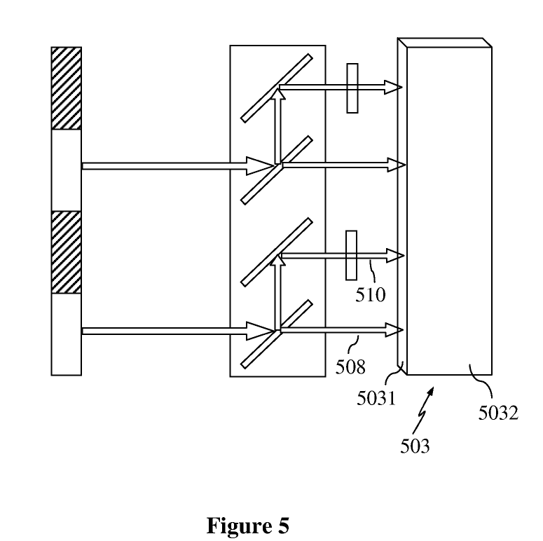

FIG. 5 illustrates a preferred embodiment of the arrangement of the polarizer and the light guide. The light guide 503 comprises a face 5031 of small area and a face 5032 of large area. The light emerging from the polarizer assembly is directed into the small face 5031. The light traverses inside the light guide and is directed to exit the light guide via the large face 5032.

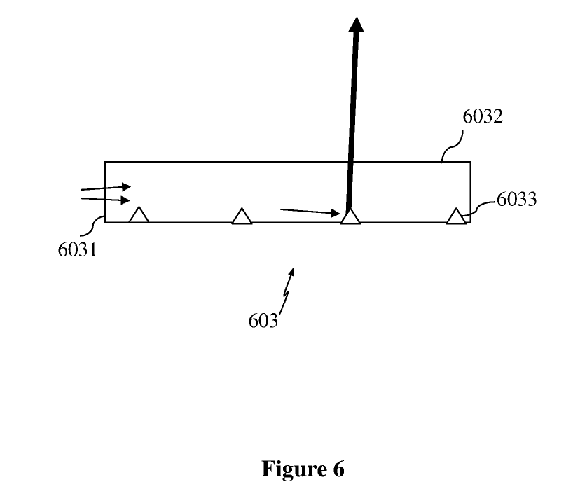

A preferred embodiment of the light guide is shown in FIG. 6, where the light guide comprises a face 6031 of small area and a large face 6032. Structures 6033 are arranged along at least one of the large faces, re-directing the passing light toward the opposite face of large area where the light exits the light guide. Examples of light re-directing structures comprise v-shaped groves, curved surfaces such as spherical or cylindrical bumps or indents. Such structures re-direct or reflect lights at their interfaces between materials of different refractive indices, and preserve the polarization of the light.

Various structures may be used to achieve the function of a polarizing apparatus of the present invention. Specific embodiments of the polarizing elements were provided in this description to illustrate the operation of the principles of this invention. The application of the principles of the present invention however is not limited by such examples. It is conceivable that various types of materials and structures may be used to construct such polarizing elements, and all such variations are embraced by the present invention.

Although various embodiments utilizing the principles of the present invention have been shown and described in detail herein, those skilled in the art can readily devise many other variances, modifications, and extensions that still incorporate the principles disclosed in the present invention. The scope of the present invention embraces all such variances, and shall not be construed as limited by the number of elements, number of layers, or specific direction and angles.

What is claimed is:

1. An illuminating apparatus comprising:
a light source;
a light guide;
wherein said light guide comprises a slab of light conducting material;
Said illuminating apparatus further comprising a plurality of polarizing elements arranged between said light source and said light guide; each said polarizing element spatially splitting the light from said light source into two light beams with polarization states orthogonal to each other.

2. The illuminating apparatus according to claim 1 wherein said light guide comprising a face of small area and a face of large area; the light from said light source entering said light guide via said small face, and exit the light guide via said large face.

3. The illuminating apparatus according to claim 2 wherein said light guide preserves substantial degree of polarization between the input light and the output light.

4. The display apparatus according to claim 1 wherein the two orthogonal polarization states are two linear polarizations perpendicular to each other.

5. The illuminating apparatus according to claim 1 wherein said light source comprises a plurality of lighting elements arranged in one-dimensional array.

6. The illuminating apparatus according to claim 1 wherein said light source comprises lighting elements of LED.

7. The illuminating apparatus according to claim 1 further comprising at least a polarization conversion device placed in the light path between said polarizing device and said light guide; said polarization conversion device change the polarization state of at least one of the two said polarized light beams.

8. The illuminating apparatus according to claim 1 wherein said light source comprises a plurality of organic light emitting elements.

9. The illuminating apparatus according to claim 7 wherein said polarization conversion device acts on the polarized lights to produce the same polarization state in the exiting light.

10. The illuminating apparatus according to claim 1 further comprising a plurality of light re-directing structures; said light re-directing structures directing the light toward said large face of the light guide.

11. The illuminating apparatus according to claim 10 wherein said light re-directing structure comprises V-shaped groves arranged on one face of said light guide.

12. The illuminating apparatus according to claim 1 wherein said at least one polarizing element transmits one component of polarization and reflect the orthogonal component of the polarization.

13. The illuminating apparatus according to claim 12, wherein said at least one polarizing element comprises a plurality of alternating layers of different indices of refraction.

14. The illuminating apparatus according to claim 12, wherein said polarizing elements comprise a plurality of repeating stacks; wherein each stack comprises at least two layers; wherein one of the two layers is optically anisotropic; wherein said two layers have substantially similar indices of refraction in one direction of polarization, and different indices of refraction in the other direction of polarization.

15. The illuminating apparatus according to claim 12 wherein said polarizing elements comprise grating with parallel metal wires.

16. A display device comprising the illuminating apparatus according to claim 1, and a two dimensional imaging device arranged in parallel with said large face of the light guide.

17. The display device according to claim 16 wherein said imaging device comprises an array of liquid crystal light valves.
